(19) United States
(12) Patent Application Publication
(10) Pub. No.: US 2021/0296799 A1
(43) Pub. Date: Sep. 23, 2021

(54) DETACHABLE PORTABLE WELDING TOOLS AND SET

(71) Applicant: Daniel O. Casillas, Central Falls, RI (US)

(72) Inventor: Daniel O. Casillas, Central Falls, RI (US)

(21) Appl. No.: 16/822,380

(22) Filed: Mar. 18, 2020

(51) Int. Cl. H01R 4/60; B23K 9/32; H01R 4/56; H02G 11/02

(52) U.S. Cl. CPC H01R 4/60; B23K 9/323; B65H 2701/34; H02G 11/02; H01R 4/56

(57) ABSTRACT

The detachable portable welding tools having short or non-existent cables provides an easy and convenient way for users in the welding industry to carry their welding tools in their toolbox. The presently claimed invention operates similarly to conventional electrode holder while eliminating the need for users to carry around excess welding cable. The detachable portable welding set attaches directly to any welding cable/lead, without the need for a long cable attached to the electrodes, thereby saving space within a toolbox and saving users time and money.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of electrode holders for arc welding. More specifically, the invention is a portable pair of tools for arc welding with short to non-existent cables and a connector that allows both parts to be plugged into the cables from the power supply.

### 2. Description of the Related Art

Arc welding is a common type of welding that uses an electrical arc to melt both the material to be welded, or welding material, and a filler material, or welding rod, to form welded joints. The three main types of arc welding are Shielded metal arc welding (SMAW or stick welding), gas tungsten arc welding (TIG), and gas metal arc welding (MIG).

In arc welding, a grounding wire is attached to the welding material or another metal surface that is in contact with the welding material. The grounding wire is commonly attached to the welding material by a clamp, such as an alligator clamp. A second wire, called the electrode lead, electrode holder, or stinger, is then placed on the material to be welded. An electric arc is generated when the electrode lead is pulled away from the material. The electric arc melts the welding material and the filler material together, joining the pieces.

Often, the welder continuously adds the filler material to the joint, although in some forms of arc welding, the welding gun adds the filler material on its own. As the filler material is added, the welder uses a back-and-forth motion to join the pieces, creating a slight raised seem along the joint.

When using a conventional electrode holder, users have to carry around ten feet of welding cable, also known as welding lead, with them. This consumes valuable space in a user's toolbox, is heavy and cumbersome, and may cause workers to trip over the long lead. It also takes a good deal of time and effort to move around and connect to the other welding cable, decreasing a user's productivity.

Ideally, a detachable portable welding set with short to non-existent cables should provide a light weight, easy to store set of grounding wire and electrode lead, with sort cables that can easily be plugged into the necessary power source and, yet would operate reliably and be manufactured at a modest expense. Thus, a need exists for a reliable detachable portable welding set of tools to avoid the above-mentioned problems.

### BRIEF SUMMARY OF THE INVENTION

In view of the foregoing disadvantages inherent in the known arc welding art, the present invention provides a novel detachable portable welding set with short cables. The general purpose of the present invention, which will be described subsequently in greater detail is to provide a detachable portable welding set with short cables.

Generally speaking, the detachable portable welding set with short cables provides an easy and convenient way for users in the welding industry to carry their welding tools in their toolbox. The presently claimed invention operates similarly to conventional electrode holder while eliminating the need for users to carry around excess welding cable. The detachable portable welding set with short to non-existent cables attaches directly to any welding cable/lead, without the need for a long cable attached to the electrodes, thereby saving space within a toolbox and saving users time and money.

The present invention holds significant improvements and serves as a detachable portable welding set with short cables. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a detachable portable welding set with short cables, constructed and operative according to the teachings of the present invention.

FIG. 1 shows a perspective view illustrating a detachable portable welding set with short cables, according to an embodiment of the presently claimed invention.

FIG. 2 is a perspective view illustrating an electrode lead, just prior to attaching the main cable, according to an embodiment of the presently claimed invention.

FIG. 3 is a perspective view illustrating how to attach the main cables to the electrode lead, according to an embodiment of the presently claimed invention.

FIG. 4 is a perspective view illustrating a grounding wire, just prior to attaching the main cable, according to an embodiment of the presently claimed invention.

FIG. 5 is a flowchart illustrating how to attach the main cables to the grounding wire, according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the present invention relate to a set of grounding cable and electrode lead for arc welding and more particularly to a detachable portable welding set with short cables as used to improve the portability and space required for storage of the welding tools, and the productivity of the welder.

The detachable portable welding set with short cables is a space saving set of welding electrodes for use pipe fitters, iron-workers, steel fabricators, and other welders.

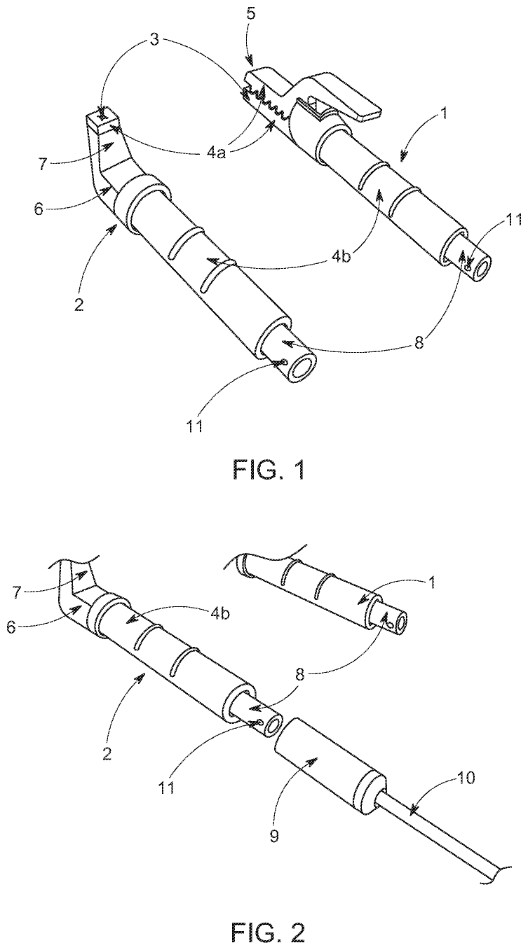

Referring to the drawings by numerals of reference there is shown in FIG. 1, a detachable portable welding set with short cables is includes a grounding wire lead 1 and an electrode lead 2. Both leads 1, 2 are made of a piece of copper 3 covered by plastic material 4, including the plastic end 4a, and the plastic material grip 4b.

The grounding wire lead 1 has a clamp-style head 5. The electrode lead 2 has a spinning head 6 with a hole in the plastic surface leading to the copper interior. The spinning head 6 has a pin 7 with an internal spring to hold a rod (not shown), used to make contact with the welding material while keeping the user's hands further away, in place so that a user can tighten it.

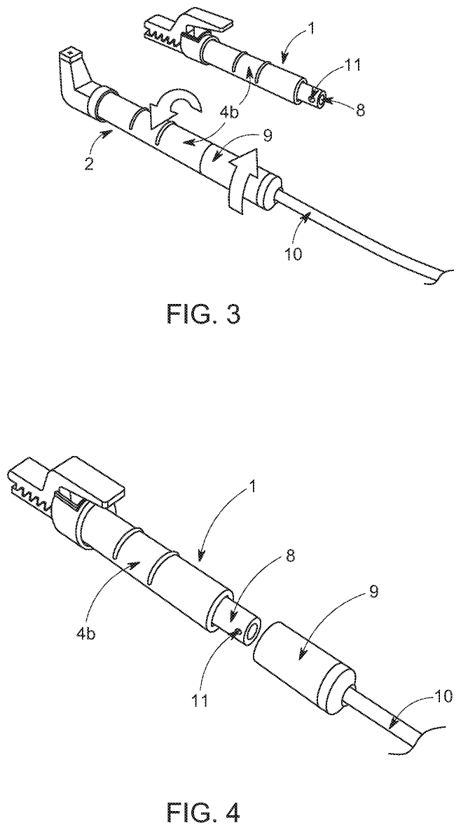

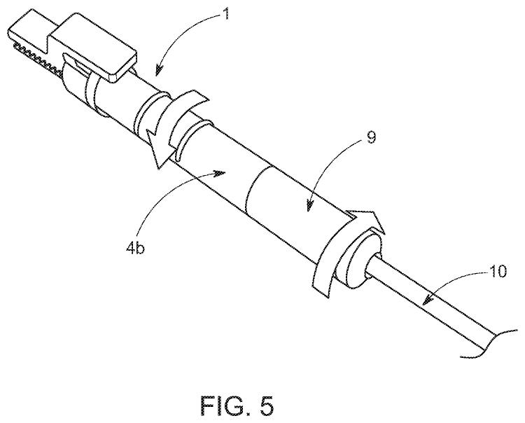

Referring now to FIGS. 2-5, the bottom ends of the grounding wire lead 1 and the electrode lead 2 both have a male end 8 that connects to a female end 8 of the cable from the power source 10. The male end 8 has tabs 11, an the female end 9 has slots, so that when the male end 8 is inserted into the female end 9 and turned, the male end 8 and the female end 10 lock together.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A detachable portable welding set with short cables comprising:
(a) a grounding wire welding tool having
(i) a clamp-style head with exposed copper teeth and a plastic housing;
(ii) at least one copper wire,
(iii) a plastic handle,
wherein the plastic handle is operably connected at a first end to the clamp-style head to allow a user to grip and move the grounding wire tool,
wherein the plastic handle has a male port with at least one tab at a second end, and
wherein the copper wire runs through the center of the plastic handle and operably connects the copper teeth of the clamp-style head to the male port; and
(b) an electrode lead welding tool having
(i) a spinning head having
(1) a copper port operably located within an opening in a face of a plastic housing;
(2) a pin with an internal a spring that compresses when the pin is pressed down and extends when the pin is released,
wherein the internal spring extends into the copper port so that a metal rod inserted into the copper port is securable by the spring when the pin is pressed down, and
wherein one end of the pin operably extends above a surface of the plastic housing so that the pin is pressable by the user;
(ii) at least one copper wire;
(iii) a plastic handle,
wherein the plastic handle is operably connected at a first end to the spinning head to allow a user to grip and move the grounding wire tool,
wherein the plastic handle has a male port with at least one tab at a second end, and
wherein the copper wire runs through the center of the plastic handle and operably connects the copper port of the spinning head to the male port.

2. A portable electrode lead welding tool comprising:
(a) a spinning head having
(i) a copper port operably located within an opening in a face of a plastic housing;
(ii) a pin with an internal a spring that compresses when the pin is pressed down and extends when the pin is released,
wherein the internal spring extends into the copper port so that a metal rod inserted into the copper port is securable by the spring when the pin is pressed down, and
wherein one end of the pin operably extends above a surface of the plastic housing so that the pin is pressable by the user;
(b) at least one copper wire;
(c) a plastic handle,
wherein the plastic handle is operably connected at a first end to the spinning head to allow a user to grip and move the grounding wire tool,
wherein the plastic handle has a male port with at least one tab at a second end, and
wherein the copper wire runs through the center of the plastic handle and operably connects the copper port of the spinning head to the male port.

3. A grounding wire welding tool comprising:
(a) a clamp-style head with exposed copper teeth and a plastic housing;
(b) at least one copper wire,
(c) a plastic handle,
wherein the plastic handle is operably connected at a first end to the clamp-style head to allow a user to grip and move the grounding wire tool,
wherein the plastic handle has a male port with at least one tab at a second end, and
wherein the copper wire runs through the center of the plastic handle and operably connects the copper teeth of the clamp-style head to the male port.
